(19) United States
(12) Patent Application Publication
(10) Pub. No.: US 2017/0371052 A1
(43) Pub. Date: Dec. 28, 2017

(54) METHOD FOR UPDATING VELOCITY MODEL USED FOR MIGRATING DATA IN 4D SEISMIC DATA PROCESSING

(71) Applicant: CGG SERVICES SAS, Massy Cedex (FR)

(72) Inventors: Julien COTTON, Paris (FR); Herve CHAURIS, Montigny sur Loing (FR); Eric FORGUES, Bures-sur-Yvette (FR)

(21) Appl. No.: 15/528,259

(22) PCT Filed: Dec. 11, 2015
(86) PCT No.: PCT/IB2015/002483

§ 371 Date: May 19, 2017

Related U.S. Application Data
(60) Provisional application No. 62/094,562, filed on Dec. 19, 2014.

(51) Int. Cl. G01V 1/30; G01V 99/00

(52) U.S. Cl. CPC G01V 1/308; G01V 99/005; G01V 2210/612

(57) ABSTRACT

A modified velocity model different from an initial velocity model is determined for migrating a vintage of 4D seismic data. The modified velocity model minimizes differences between a reference vintage migrated using the initial velocity model and the vintage migrated using the modified velocity model.

### CROSS REFERENCE TO RELATED APPLICATIONS

This application claims priority and benefit from U.S. Provisional Patent Application No. 62/094,562 filed on Dec. 19, 2014, for “Method for Migration Velocity Analysis in 4D Seismic,” the entire content of which is incorporated in its entirety herein by reference.

### BACKGROUND

### Technical Field

Embodiments of the subject matter disclosed herein generally relate to 4D seismic data processing, more particularly, to determining a modified velocity model used to migrate a vintage of the 4D seismic data set, the modified model being different from an initial velocity model used to migrate a reference vintage of the 4D seismic data set.

### Discussion of the Background

Nowadays, the oil and gas industry uses repeated seismic surveys to monitor the evolution of oil and gas reservoirs in order to anticipate and adapt production. Repeated seismic survey data (known as “4D seismic data,” or time-lapse data) is used to monitor onshore and offshore changes of underground formations around reservoirs. Seismic surveys use seismic excitations emitted by seismic sources (such as explosives, vibrator trucks, air guns, etc.) that propagate into and are partially reflected back by underground formations. Seismic data is recorded when reflections emerging from the underground formations are detected by seismic sensors (such as hydrophones, geophones, accelerometers, optical fiber, etc.). Seismic data includes sequences of sampled time-varying signals detected at known seismic sensor positions. The time interval between when a seismic wave is emitted and when its reflections reach a detector is known as two-way time (TWT). TWT is correlated with the reflector's depth and the velocity field in between source, reflector and receiver. Seismic data is then processed to generate images of the underground formations. Evolution of the underground formation is tracked using successive images based on data from different surveys.

Time intervals between surveys (e.g., days, weeks, months) substantially exceed survey durations (e.g., seconds or minutes at a location, up to hours, over a targeted area). Data collected during one of the surveys is known as a vintage. The data in different vintages may be acquired with same or different methods and equipment (e.g., design and recording system), but the surveys are performed over the same surveyed area.

4D variations from one survey to the next (e.g., signal travel time variations, amplitude variations at the same location, etc.) correspond to changes of the underground formations' physical properties, which changes have occurred between surveys. Seismic wave propagation velocity, which is among the physical properties that vary over calendar time, may be modified due to changes in conditions such as temperature and pressure. For example, these conditions vary significantly when oil is extracted from a reservoir. Rapid changes of the temperature and pressure (as well as density, porosity, etc.) are often observed for Enhanced Oil Recovery (EOR) as fluid is injected into the reservoir (steam, gel, water, etc.).

One of the monitored 4D attributes is the travel time variation (ΔT), which is often measured by cross-correlation of traces corresponding to a same location in different repeated seismic surveys. Overall ΔT is an integration of a velocity variation over layers.

FIG. 1 illustrates a conventional seismic data processing flow used for repeated surveys. The seismic data sets acquired at “Acquisition 1,” “Acquisition 2,” “Acquisition 3” and “Acquisition 4” are first migrated using a same velocity model V0. The migration may be in time (i.e., pre-stack time migration, PSTM) or in depth (i.e., pre-stack depth migration, PSDM). After migration, attributes such as Δt are computed and correlated between the migration outputs corresponding to the different seismic data sets.

When seismic data is processed in this conventional manner, separating 4D effects due to real changes is challenging, and the results are unstable (i.e., large variations occur in results due to small fluctuations of the processing conditions). Besides reflecting real changes, travel time variations are also dependent on the distance between the source and the receiver (sometimes called detector or sensor). Therefore, it is difficult to assess whether a physical property variation caused a velocity variation. When the velocity variation is not taken into account, different offset (i.e., different distance source-to-receiver) dependent dynamic variations may be misinterpreted as 4D amplitude versus offset (AVO) effects.

Therefore, it would be desirable to provide methods for migrating 4D seismic data without the above-outlined drawbacks of conventional methods.

### SUMMARY

In various embodiments, different vintages are migrated with different velocity models. An updated velocity model used to migrate a vintage may be determined such that to minimize differences between a reference vintage migrated with a reference (or initial) velocity model and the vintage migrated with the updated velocity model (which is different from the reference velocity model).

According to an embodiment there is a method for updating a velocity model used for migrating 4D seismic data. The method includes receiving a first data set and a second data set that are vintages of the 4D seismic data, and migrating the first data set using an initial velocity model to obtain a first migrated data set. The method further includes determining a modified velocity model to be applied to the second data set so that an objective function measuring differences between the first migrated data set and migrated second data set is minimized.

According to another embodiment, there is a seismic data processing apparatus including an interface configured to receive a first data set and a second data set that are vintages of 4D seismic data, and a data processing unit. The data processing unit is connected to the interface and includes at least one processor. The data processing unit is configured to migrate the first data set using an initial velocity model to obtain a first migrated data set, and to determine a modified velocity model to be applied to the second data set so that an objective function measuring differences between the first migrated data set and migrated second data set is minimized.

According to yet another embodiment, there is a computer-readable medium storing executable codes which, when executed by a computer, make the computer perform a method for migrating 4D seismic data. The method includes receiving a first data set and a second data set that are vintages of the 4D seismic data, and migrating the first data set using an initial velocity model to obtain a first migrated data set. The method further includes determining a modified velocity model to be applied to the second data set so that an objective function measuring differences between the first migrated data set and migrated second data set is minimized.

### BRIEF DESCRIPTION OF THE DRAWINGS

The accompanying drawings, which are incorporated in and constitute a part of the specification, illustrate one or more embodiments and, together with the description, explain these embodiments. In the drawings:

FIG. 1 illustrates data flow for a conventional processing of vintages;

FIG. 2 is a flowchart of a method according to an embodiment;

FIG. 3 illustrates data flow for processing vintages according to an embodiment;

FIG. 4 illustrates traces acquired at a same location during 20 successive days, migrated using an initial velocity model;

FIG. 5 illustrates amplified differences between the traces in days 2-20 and the first day trace in FIG. 4;

FIG. 6 illustrates the traces acquired at a same location during 20 successive days, migrated using a calendar dependent velocity model;

FIG. 7 illustrates amplified differences between the traces in days 2-20 and the first day trace illustrated in FIG. 6;

FIG. 8 illustrates values of the objective function J decreasing during successive iterations of the method;

FIGS. 9-12 visualize the effect of iterative improvements; and

FIG. 13 is a schematic diagram of an apparatus configured to process 4D seismic data and update a velocity model used in migrating the data according to an embodiment.

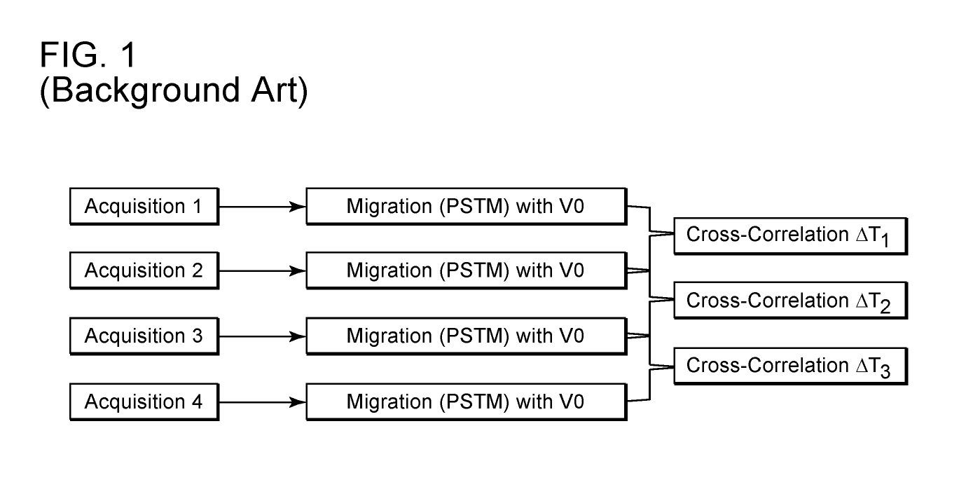

### DETAILED DESCRIPTION

The following description of the exemplary embodiments refers to the accompanying drawings. The same reference numbers in different drawings identify the same or similar elements. The following detailed description does not limit the invention. Instead, the scope of the invention is defined by the appended claims. The following embodiments are discussed using terminology of 4D seismic data processing. The 4D seismic data processed using the various embodiments may have been acquired on land, seabed or in a marine environment.

Reference throughout the specification to “one embodiment” or “an embodiment” means that a particular feature, structure or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments.

In some embodiments, instead of migrating seismic data using the same velocity model, adequate/updated velocity model(s) is/are determined to minimize an objective function measuring differences between a reference data set migrated with an initial model and other data set(s) migrated using the adequate/updated velocity model(s). The data sets refer to the same surveyed area.

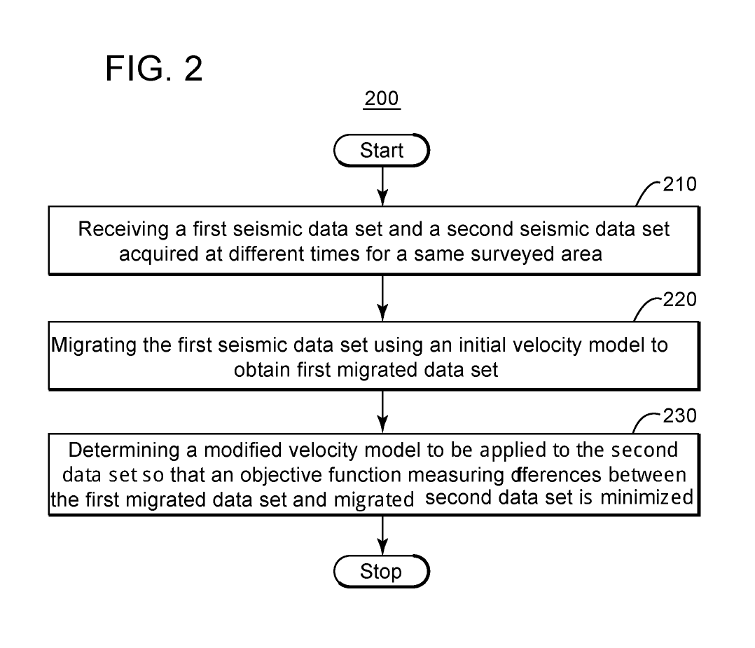

FIG. 2 is a flowchart of a method 200 according to an embodiment. Method 200 includes receiving a first data set and a second data set acquired during different surveys for the same surveyed formation, at 210. The first and second data set are thus vintages of 4D seismic data. The first data set may be the earliest acquired, set sometimes called baseline data set, and the second set is then acquired later than the first data set sometimes called a monitor data set.

Method 200 further includes migrating the first data set using an initial velocity model to obtain first migrated data set, at 220. At 230, a modified velocity model for migrating the second data set is determined such that an objective function measuring differences between the first migrated data set and migrated second data set is minimized.

In one embodiment, step 230 includes iteratively generating a version of a velocity model (e.g., by perturbing the initial velocity model), migrating the second data set using the version of the velocity model to obtain a version of migrated second data set, and calculating an updated value of the objective function using the version of the migrated second data. The modified velocity model is the version of the velocity model yielding the smallest value of the objective function.

### Updating the Velocity Model

Migration Velocity Analysis (MVA) is a family of methods that estimate the background velocity model describing the kinematics of wave propagation (see, e.g., the article, “Velocity analysis by iterative profile migration,” by K. Al-Yahya, published in 1989 in Geophysics, vol. 54, pp. 718-729). These methods analyze the reflected waves without picking specific horizons. The quality of the velocity model is estimated through an objective function defined in the image domain. Among several possibilities, the semblance approach aims at maximizing the stacking energy. However, the objective function may exhibit local minima for an inaccurate initial velocity model. Differential Semblance Optimization (DSO) is a possible automatic and iterative method to derive the background model (see, e.g., the articles, “Velocity inversion by differential semblance optimization,” by Symes, W., and J. J. Carazzone, published in 1991 in Geophysics, vol. 56, pp. 654-663, and, “Migration velocity analysis and waveform inversion,” by Symes, W. W., published in 2008 in Geophysical Prospecting, vol. 56, pp. 765-790). The methods are based on the assumption that images (i.e., migrated data) obtained from subsets of different data sets but related to the same formation are consistent if data was migrated using a correct velocity model. In other words, Common Image Gathers (CIGs) should display horizontal events, whatever the reflectivity structure. Non-flat events indicate that the background velocity model should be updated. In the original definition, the DSO function measures the norm between two successive images:

$${J}_{DSO} [ v ] = \frac{1}{2} \int dh \int {dx [ \frac{\partial I}{\partial h} [ v ] ( x , h ) ]}^{2} \qquad ( 1 )$$

where I is the image generated from migrated data, with data being migrated using the velocity model v(x) and for the offset h. The spatial coordinates x=(x,y,z) are three-dimensional. DSO methods aim to derive a unique velocity model so that all migrated sections are consistent.

For sparse and narrow offset range data sets, it is not possible to directly use DSO methods. Since seismic data is related to the same formation, a velocity model may be determined using a different objective function than in the DSO approach.

According to an embodiment (e.g., method 200), for repeated acquisitions, a velocity model is determined so as to minimize the differences between migrated outputs of data from different surveys. The migration may be in time (i.e., pre-stack time migration, PSTM) or in depth (i.e., pre-stack depth migration, PSDM).

An initial velocity model, V0, is used for migrating the first data set, p_{obs1}:

m₁=M_{(V0)}p_{obs1} (2)

where M is a migration operator and m is migrated data.

Model V0 is updated to V0+δV and used to migrate the second data set p_{obs2}:

m₂=M_{(V0+δV)}p_{obs2}, (3)

Iterative methods may seek the velocity perturbation δV, which minimizes function J:

J(δV)=Σ∥m₁−m₂∥=Σ∥M_{V0}P_{obs1}−M_{(v0+δV)}p_{obs2}∥. (4)

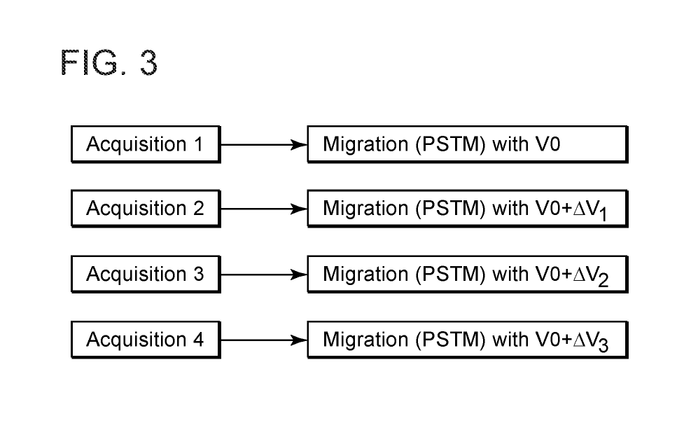

In the above description, data from only two repeated acquisitions (p_{obs1} and p_{obs2}) is migrated. However, plural repeated acquisitions could be migrated simultaneously. FIG. 3 illustrates a seismic data processing flow used for repeated surveys according to an embodiment. The seismic data sets acquired at “Acquisition 1,” “Acquisition 2,” “Acquisition 3” and “Acquisition 4” are migrated using different velocity models V0, V0+δV₁, V0+δV₂, etc. Usually “Acquisition 1” is the first survey, but it may be a reference survey. That is, order indicated by 1, 2, 3, 4 should not be interpreted in a limiting manner as meaning survey-time order. In other words, while “Acquisition 1” may refer to a data set acquired first in time, it may also be any later acquired other vintage. The time order is not required feature.

The minimization may be performed so as to satisfy some constraints. For example, spatial constraints may limit variations of the velocity model not to exceed a predetermined threshold between adjacent locations. Temporal (calendar) constraints may impose a consistent trend in local or global velocity variations.

Returning now to method 200 illustrated in FIG. 2, determining step 230 may include an initiation phase. The initiation phase includes migrating the second seismic data using the initial velocity model to obtain initial migrated second seismic data, setting a reference objective function value equal to a value of the objective function calculated using the initial migrated second data, and setting the modified velocity model equal to the initial velocity model.

Determining step 230 may also include the iteration phase. The iteration phase includes iteratively: generating a version of a velocity model, migrating the second seismic data using the version of velocity model to obtain a version of the migrated second seismic data, and calculating an updated value of the objective function using the version of the migrated second data, and, if the updated value is smaller than the reference objective function value, the reference objective function value is set equal to the updated value, and the modified velocity model is set to the current version of the velocity model.

The version of a velocity model may be generated according to predetermined rules, which may include observing spatial and/or temporal constraints. For example, a constraint may be the velocity model to remain the same for layers above the reservoir. In another example, a constraint may be that the velocity cannot vary more than 5% from a previous/initial velocity value in any location.

Predetermined rules may also include developing a strategy for generating versions of velocity model based on previous iterations' results. In other words, previous iterations' results are taken into consideration when generating a version of the velocity model.

The iterative process may be performed a predetermined number of times, and/or until a predetermined criterion is met. In one embodiment, the predetermined criterion may be related to achieving an objective function value that is less than a predetermined percentage from an initial value. In another embodiment, the predetermined criterion may be related to no longer achieving significant improvement (lowering) of the objective function's value (e.g., no improvement larger than 0.1% observed during the last 10 iterations).

In one embodiment, the version of velocity model is generated by cross-correlating migrated traces from the first and second data sets, respectively, using sliding travel time windows. For example, velocity in a travel time interval identified based on cross-correlating of the migrated traces may be updated linearly relative to a duration of the travel time interval.

### Velocity Model as Calendar Time Function

4D seismic data may include sets of data acquired daily. The velocity model may be formulated as a function of calendar time, c. The objective function to be minimized is the:

$${J}_{4 d} [ v ( c ) ] = \frac{1}{2} \int d c \int {dx [ \frac{\partial I}{\partial c} [ v ( c ) ] ( x ) ]}^{2} . \qquad ( 5 )$$

The objective of minimization is to derive a series of velocity models v(c) (e.g., an instance of velocity function is a model for every day) and not individual models for each data set. The partial derivative with respect to c means that v(c+5c)−v(c) is related to changes of the velocity model between calendar time c and calendar time c+5c.

An initial velocity model v₀=v(c=0) is usually known (e.g., obtained using other methods or inferred based on measurements). The objective function J_{4d} may then be iteratively minimized. Each data set recorded at a time c is migrated in the model v(c), yielding I[v(c)].

In one embodiment, for each I(c) image travel time, variations may be derived using a cross-correlation approach. Local cross-correlation is performed on sliding windows between I(c) and I(c+δc). The sign of the cross-correlation indicates if the velocity value should locally be increased or decreased. More than that, the magnitude travel time variation values reflect if the model should be largely updated or not. The velocity model may be updated proportionally to the picked travel time difference according to:

vᵢ₊₁=vᵢ+k·Δtᵢ (6)

where Δtᵢ is the picked travel time differences at iteration i. The scalar k is an adaptation factor that transforms travel time variations into velocity changes. For fixed Δₜᵢ and vᵢ, several k values may be tested until J_{4d} becomes smaller, optimally minimum. As k is scalar, this is a one-dimensional minimization problem for which the data set at calendar time c should be migrated in different v+k Δtᵢ models.

One of the above-described methods has been used to process a synthetic data set emulating the context of steam-assisted heavy oil recovery, with an injected well. The data set fits the geometry of the real data, with buried sources and receivers. The acquisition fold is low (around 5) and offsets range from 200 to 600 meters. The geological context includes only horizontal reflectors and represents 20 data vintages corresponding to daily acquisitions. The initial velocity model has a constant velocity gradient, with velocities from 2,000 m/s at 0 m depth, to 2,800 m/s at a depth corresponding to about 0.6 second two-way-time. Time-lapse effect is created by introducing small velocity perturbations every day, up to 2% of the initial velocity model. Local velocity changes are located at a migrated time of 0.620 second to reproduce an effect similar to a real case.

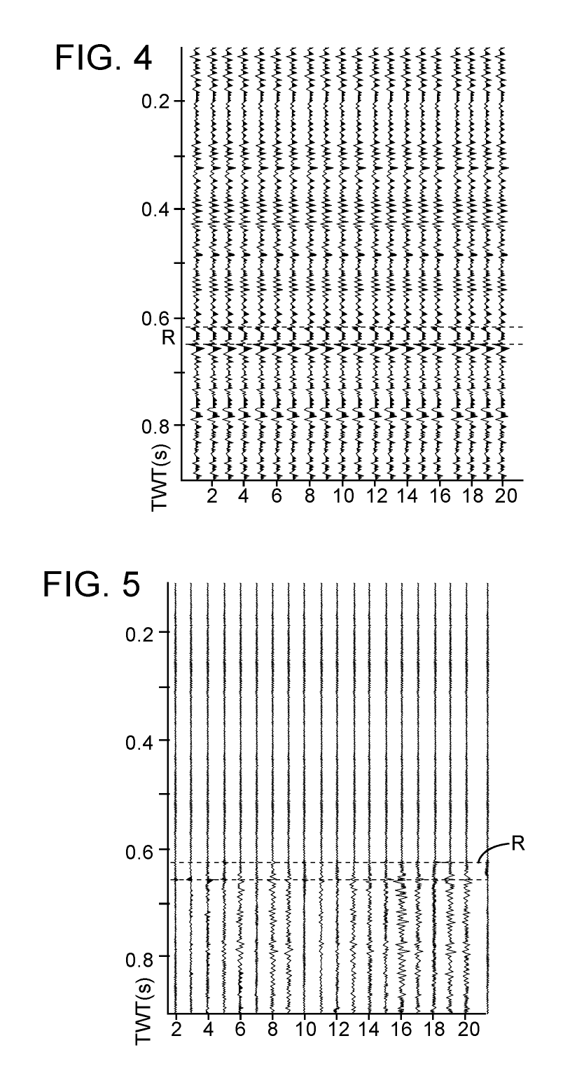

FIG. 4 illustrates migrated traces I(c) corresponding to the same location for the 20 data sets. In FIGS. 4-7 described below, the vertical axis corresponds to two-way-time and the horizontal axis to days. A reservoir location R is marked by the dashed line rectangle and labelled R. The differences between the traces are not apparent to the naked eye. FIG. 5 illustrates amplified differences between traces in different sets I(c+δc)−I(c) (multiplied with 5) that reveal variations located at the reservoir or below the reservoir level. In fact, when generating the synthetic data, velocity has been perturbed only inside the reservoir, but after migration, changes also appear below the reservoir, with the velocity modification inducing kinematic effects. Velocity modification may also cause amplitude variations.

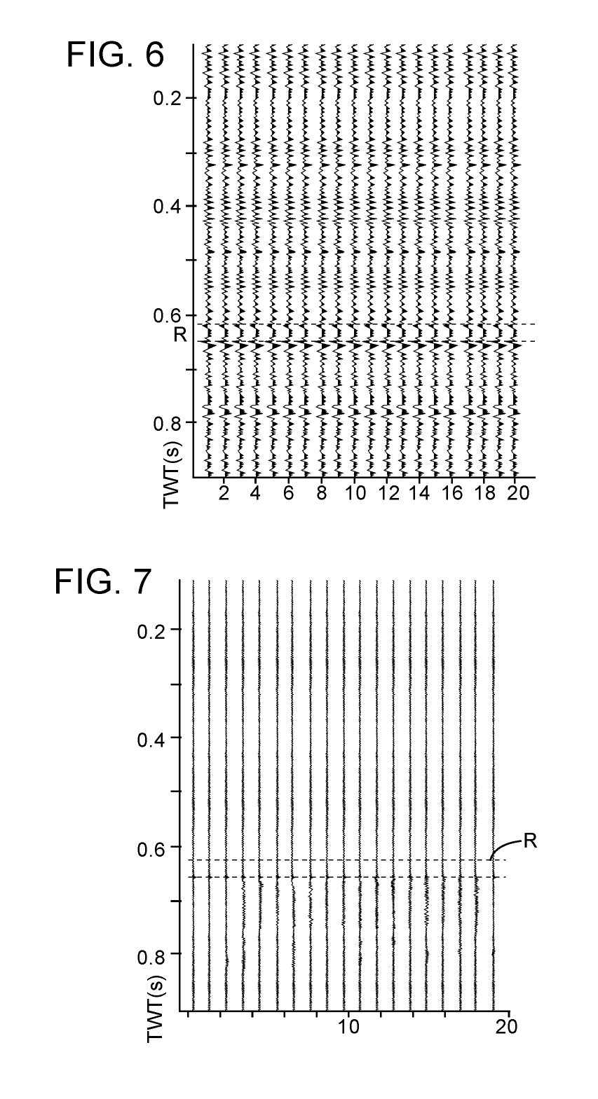

FIGS. 6 and 7 illustrate the same traces and differences as FIGS. 4 and 5, but the traces have now been migrated using calendar dependent velocity models obtained after few iterations. A comparison of FIGS. 5 and 7 reveals that when calendar dependent velocity models are used, the traces' differences below the reservoir layer R disappear.

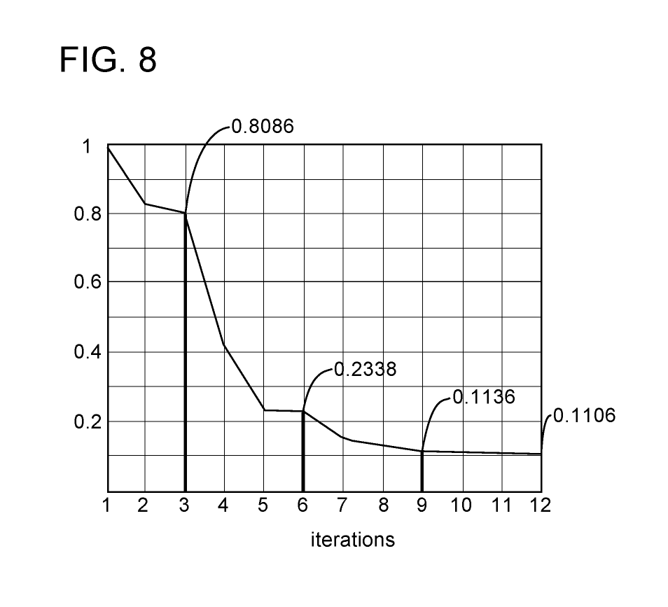

FIG. 8 illustrates values of the objective function J_{4d} during the minimization process, with the horizontal axis corresponding to the number of iterations.

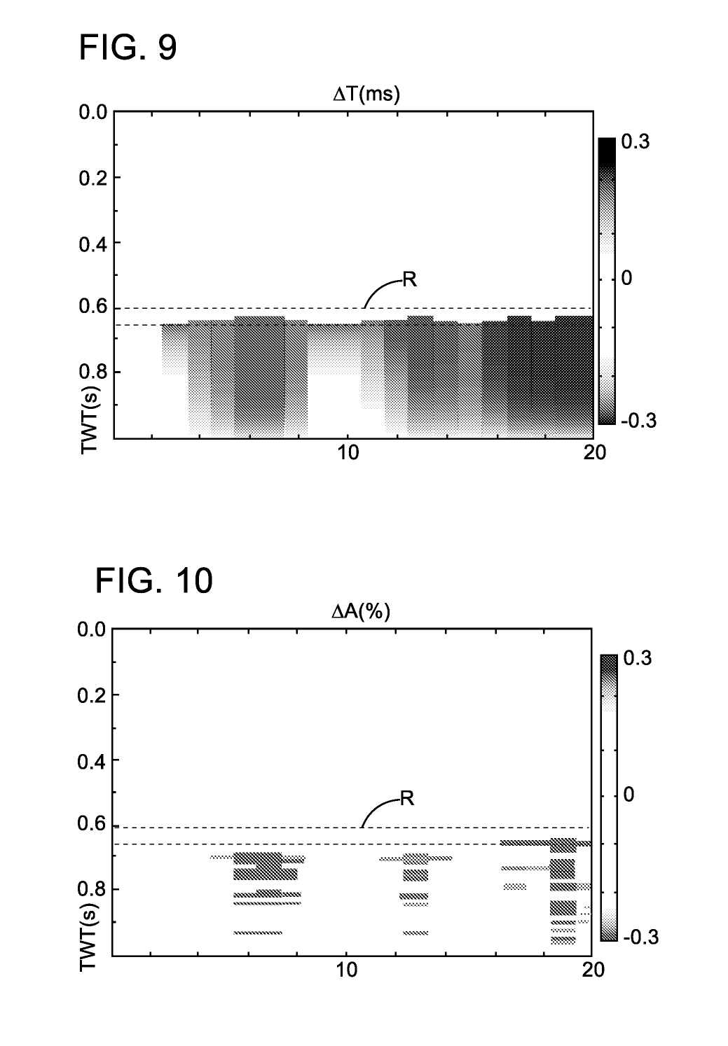

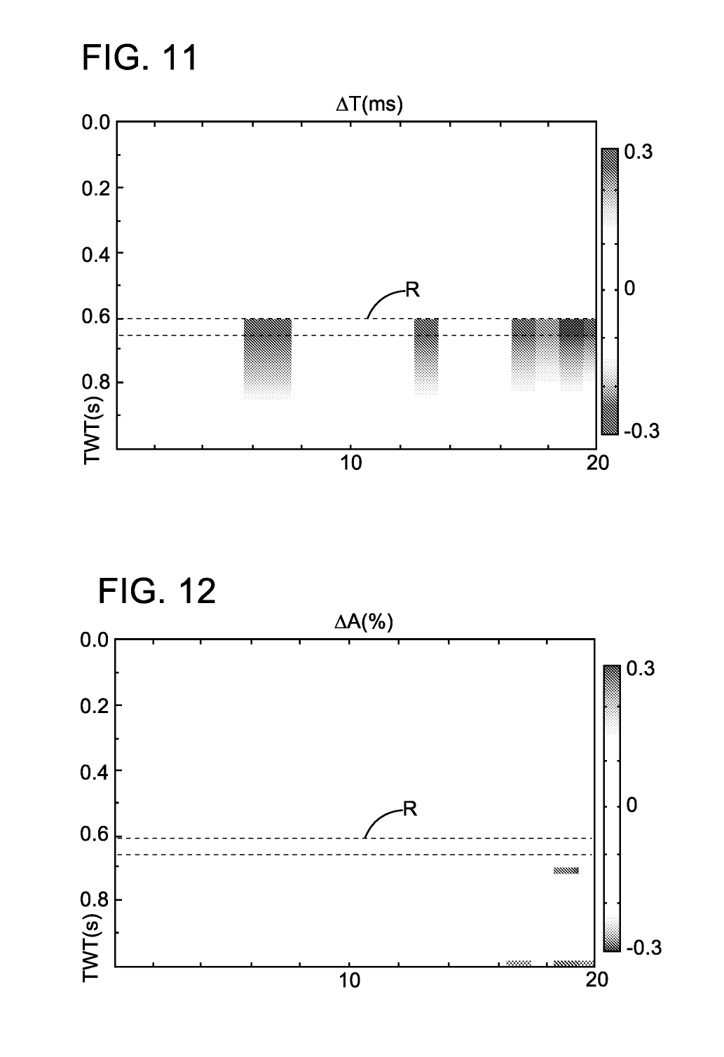

Another way to visualize the effect of iterative improvements is illustrated by the graphs in FIGS. 9 to 12. FIGS. 9 and 10 illustrate initial time and amplitude variations induced by changes in the reservoir area for the synthetic 20 data sets. FIGS. 11 and 12 illustrate time and amplitude variations obtained when velocity models obtained after a number of iterations are used to migrate the data. A comparison of graphs 9 and 11 shows that the time differences are correctly identified in the reservoir region when updated velocity models are used. Similarly, a comparison of graphs 10 and 12 shows that amplitude differences practically disappear outside the reservoir.

The interval velocities variations may then be calculated from the 4D updated migration velocities (integration of the velocity from the surface) using existing known methods (e.g., Dix formula, described in the article, “Seismic Velocities from surface measurements,” by Dix, C. H., published in 1955 in Geophysics, vol. 20, no. 1, pp. 68-86). Computation of the interval velocity can be performed with or without using geological horizons. Calculating the interval velocities is a first way to update the velocity model (direct problem). A second way is to perform the inverse process: starting from an initial interval velocity model, the migration velocity can be computed (e.g., via inverse Dix formula) and the result may be tested as to whether it effectively minimizes the differences between the data set from the repeated acquisitions. In some cases, using the second way would be more constrained by geological information.

### Updating the Velocity Model and the Density Model

The formalism used in this section is known as Quantitative 4D Pre-Stack Time Migration. Under the Born's approximation, 4D seismic data d₀ and dₙ acquired during different surveys can be written as:

d₀=M₍ᵥ_{₀}₎r₀ (7)

dₙ=M₍ᵥ_{ₙ}₎rₙ (8)

where M is the modeling operator (including the seismic wavelet), v₀ and vₙ are the background velocity models. The reflectivities of the subsoil are noted r₀ and rₙ and can be written as:

r₀=M₍ᵥ_{₀}₎d₀ (9)

rₙ=M₍ᵥ_{ₙ}₎dₙ (10)

where M^{T} is the adjoin of the modeling operator.

Considering waves that are incident to a geological layer interface between two media at normal incidence, the relationship between the interface's reflectivity and acoustic impedances can be written as follows:

$$r = \frac{{i}_{a} - {i}_{b}}{{i}_{a} + {i}_{b}} \qquad ( 11 )$$

where iₐ and i_{b} are the acoustic impedance of a first and a second medium.

Thus, the reflectivity can be seen as the derivative of the acoustic impedance, and the impedance as the integration of the reflectivity. Based on this observation, Waters K. H. (1992 Reflection Seismology: A tool for energy resource exploration, Krieger Publishing Company, 538 p., ISBN: 0894647121, 9780894647123) showed that band-limited impedance generation is equivalent to applying a 90 degree phase rotation and high-cut filter of 6 db per octave to a zero phase migrated seismic data and is similar to the pseudo log described by Anstey, N. A. (1982, Simple Seismic: Boston International Human Research Development Corporation, 168 p.). The relationship between the band-limited impedance and the seismic data can be written as follows:

i=Wr=WM₍ᵥ₎^{T}d (12)

where W is the integration filter. The acoustic impedance i is defined by the following equation:

i=p·v (13)

where p is the density of the rock and v is the velocity of the seismic wave in the rock.

It can then be written that:

p·v=WM₍ᵥ₎^{T}d (14)

which for the two data sets means:

p₀·ᵥ₀=WM₍ᵥ_{₀}₎^{T}d₀ (15)

pₙ·vₙ=WM₍ᵥ_{ₙ}₎^{T}dₙ (16)

Starting from the velocity and the density variations expressed as:

pₙ=p₀+Δp (17)

vₙ=v₀+Δv (18)

equation (18) is equivalent with:

(p₀+Δp)·(v₀+Δv)=WM₍ᵥ_{₀}_{+Δv)}^{T}dₙ (19)

which can be rewritten as:

$$( 1 + \frac{Δ p}{{ρ}_{0}} + \frac{Δ v}{{v}_{0}} ) \cdot {ρ}_{0} \cdot {v}_{0} = {WM}_{( {v}_{0} + Δ v )}^{T} {d}_{n} \qquad ( 20 )$$

and using p₀·v₀ expression from equation 15:

$$( 1 + \frac{Δ p}{{ρ}_{0}} + \frac{Δ v}{{v}_{0}} ) \cdot {WM}_{( {v}_{0} )}^{T} {d}_{0} = {WM}_{( {v}_{0} + Δ v )}^{T} {d}_{n} \qquad ( 21 )$$

In order to minimize the energy, the left and the right part of the above equation should match. The above equation (21) is known as the quantitative 4D-PSTM (pre-stack time migration) equation, and can be solved iteratively to minimize J(Δv,Δp):

$$J ( Δ v , Δρ ) = \sum {‖ {WM}_{( {v}_{0} + Δ v )}^{T} {d}_{n} - ( 1 + \frac{Δ ρ}{{ρ}_{0}} + \frac{Δ v}{{v}_{0}} ) \cdot {WM}_{( {v}_{0} )}^{T} {d}_{0} ‖}^{2} \qquad ( 22 )$$

The kinematics effect being given by:

J(Δv)=Σ∥M₍ᵥ_{₀}_{+Δv)}^{T}dₙ−M₍ᵥ_{ₒ}₎^{T}d₀∥² (23)

the velocity variation Δv is found when the gradient of the objective is equal to zero:

grad(J(Δv))=0. (24)

Here, Δv corresponds to a root-mean-square (RMS) velocity variation that integrates velocity changes over the time. The interval velocity between geological horizons may be obtained using Dix's formula to estimate the velocity change in the reservoir.

Once the kinematics effect is taken into consideration, the objective function's residue is assumed to be due to the amplitude term. Rewriting equation 21 as:

$$( 1 + \frac{Δ p}{{ρ}_{0}} + \frac{Δ v}{{v}_{0}} ) = \frac{{WM}_{( {v}_{0} + Δ v )}^{T} {d}_{n}}{{WM}_{( {v}_{0} )}^{T} {d}_{n}} \qquad ( 25 )$$

the ratio on the right side of the equal sign may be evaluated without windowing due to the integration term W. Therefore, with windowing no longer required, the vertical resolution of the ratio is not limited by a computing window, but only by the seismic bandwidth. The density variation Δp can be written as:

$$Δ ρ = {ρ}_{0} ( \frac{{WM}_{( {v}_{0} + Δ v )}^{T} {d}_{n}}{{WM}_{( {v}_{0} )}^{T} {d}_{n}} - 1 - \frac{Δ v}{{v}_{0}} ) \qquad ( 26 )$$

When replacing p₀ (in view of equation 14) with:

$${ρ}_{0} = \frac{1}{{v}_{0}} {WM}_{( {v}_{0} )}^{T} {d}_{0} \qquad ( 27 )$$

the density variation formula (20) becomes:

$$Δ ρ = {WM}_{( {v}_{0} )}^{T} {d}_{0} ( \frac{{WM}_{( {v}_{0} + Δ v )}^{T} {d}_{n}}{{v}_{0} {WM}_{( {v}_{0} )}^{T} {d}_{0}} - \frac{1}{{v}_{0}} - \frac{Δ v}{{v}_{0}^{2}} ) . \qquad ( 28 )$$

In view of the above-outlined formalism, the density and the velocity variation can be estimated simultaneously by solving iteratively, without reservoir information, the full quantitative 4D-PSTM (equation 22). Alternatively, the density and the velocity variation can be estimated separately by solving iteratively equation 23 and equation 28 by decoupling kinematics effect and amplitude effects. The decoupling of the kinematics effect and the amplitude effect can be used for small velocity changes; otherwise, the full quantitative 4D-PSTM yields better results.

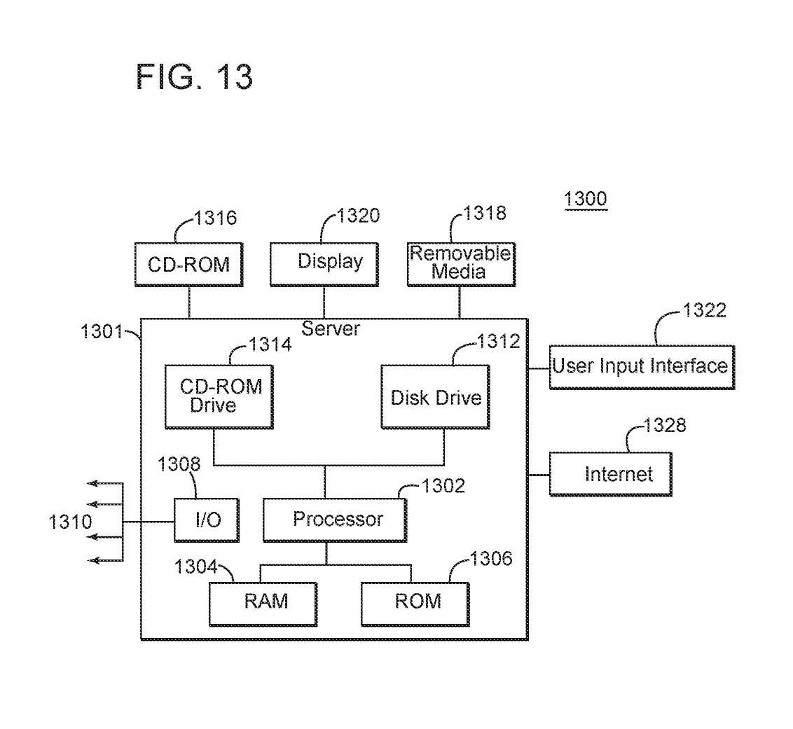

The above-described methods may be performed using the apparatus in FIG. 13. Hardware, firmware, software or a combination thereof may be used to perform the various steps and operations. Apparatus 1300 may include server 1301 having a central processor unit (CPU) 1302 coupled to a random access memory (RAM) 1304 and to a read-only memory (ROM) 1306. ROM 1306 may also be other types of storage media to store programs, such as programmable ROM (PROM), erasable PROM (EPROM), etc. Methods for updating velocity models used to migrate 4D seismic data may be implemented as computer programs (i.e., executable codes) non-transitorily stored on RAM 1304 or ROM 1306.

Processor 1302 may communicate with other internal and external components through input/output (I/O) circuitry 1308 and bussing 1310, which are configured to receive the first data set and the second data set acquired by surveying the same underground formation (i.e., are vintages of 4D seismic data). Processor 1302 carries out a variety of seismic data processing functions, as dictated by software and/or firmware instructions, and may include plural processing elements cooperating to perform the data processing functions.

Processor 1302 is configured to determine a modified velocity model to be used to migrate the second data set so that an objective function measuring differences between the first migrated seismic data and migrated second seismic data is minimized.

Server 1301 may also include one or more data storage devices, including disk drive 1312, CD-ROM drive 1314, and other hardware capable of reading and/or storing information, such as a DVD, etc. In one embodiment, software for carrying out the above-discussed steps may be stored and distributed on a CD-ROM 1316, removable media 1318 or other form of media capable of storing information. The storage media may be inserted into, and read by, devices such as the CD-ROM drive 1314, disk drive 1312, etc. Server 1301 may be coupled to a display 1320, which may be any type of known display or presentation screen, such as LCD, plasma display, cathode ray tube (CRT), etc. Server 1301 may control display 1320 to exhibit images generated using seismic data.

User input interface 1322 includes one or more user interface mechanisms such as a mouse, keyboard, microphone, touch pad, touch screen, voice-recognition system, etc. Server 1301 may be coupled to other computing devices, such as the equipment of a vessel, via a network. The server may be part of a larger network configuration as in a global area network (GAN) such as the Internet 1328, which allows ultimate connection to various landline and/or mobile devices.

The disclosed exemplary embodiments provide methods for updating a velocity model used in migrating one or more vintages of 4D seismic data. It should be understood that this description is not intended to limit the invention. On the contrary, the exemplary embodiments are intended to cover alternatives, modifications and equivalents, which are included in the spirit and scope of the invention as defined by the appended claims. Further, in the detailed description of the exemplary embodiments, numerous specific details are set forth in order to provide a comprehensive understanding of the claimed invention. However, one skilled in the art would understand that various embodiments may be practiced without such specific details.

Although the features and elements of the present exemplary embodiments are described in the embodiments in particular combinations, each feature or element can be used alone without the other features and elements of the embodiments or in various combinations with or without other features and elements disclosed herein.

This written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended to be within the scope of the claims.

1. A method for updating a velocity model used for migrating a vintage of 4D seismic data, the method comprising:
receiving a first data set and a second data set that are vintages of the 4D seismic data;
migrating the first data set using an initial velocity model to obtain a first migrated data set; and
determining a modified velocity model that minimizes an objective function measuring differences between the first migrated data set and the second data set migrated using the modified velocity model.

2. The method of claim 1, wherein the determining includes:
migrating the second data set using the initial velocity model to obtain initial migrated second data set;
setting a reference objective function value equal to a value of the objective function calculated using the initial migrated second data set, and setting the modified velocity model equal to the initial velocity model; and
iteratively:
generating a version of velocity model,
migrating the second data set using the version of velocity model to obtain a version of the migrated second data set,
calculating an updated value of the objective function using the version of the migrated second data set,
if the updated value is smaller than the reference objective function value, set the reference objective function value equal to the updated value, and set the modified velocity model equal to the version of the velocity model.

3. The method of claim 2, wherein the generating of the version of velocity model is performed according to predetermined rules.

4. The method of claim 3, wherein the predetermined rules include observing spatial and/or temporal constraints.

5. The method of claim 3, wherein the predetermined rules include taking into consideration previous iterations' results.

6. The method of claim 2, wherein a predetermined number of iterations are performed or the iteratively performing stops when a predetermined criterion is met.

7. The method of claim 2, wherein the version of the velocity model is generated based on comparing the first migrated data set with the second data set migrated using a previous version of the velocity model.

8. The method of claim 7, wherein, based on the comparing, a velocity in a travel time interval is updated linearly relative to a duration of the travel time interval.

9. The method of claim 1, wherein the first data set and the second data set are migrated in time or in depth.

10. The method of claim 1, further comprising:
receiving a third seismic data set; and
determining another modified velocity model by minimizing another objective function measuring differences between the first migrated data set and/or the second data set migrated using the modified velocity model, and the third seismic data set migrated using the other modified velocity model.

11. The method of claim 1, further comprising:
receiving at least one other data set;
generating a calendar-dependent velocity function of calendar time so that the initial velocity model equals a value of the calendar-dependent velocity function for a first calendar time when the first data set was acquired;
determining parameters of the calendar-dependent modified velocity function by minimizing a calendar-dependent objective function measuring differences between the first migrated data set, and the second data set and the at least one other data set migrated using velocity models calculated using the calendar-dependent velocity function for calendar times when the second and the at least one other data set were acquired, respectively.

12. A seismic data processing apparatus, comprising:
an interface configured to receive a first data set and a second data set that are vintages of 4D seismic data; and
a data processing unit connected to the interface and including at least one processor, the data processing unit being configured
to migrate the first data set using an initial velocity model to obtain a first migrated data set, and
to determine a modified velocity model that minimizes an objective function measuring differences between the first migrated data set and the second data set migrated using the modified velocity model.

13. The apparatus of claim 12, wherein the data processing unit determines the modified velocity model by:
migrating the second data set using the initial velocity model to obtain initial migrated second data set;
setting a reference objective function value equal to a value of the objective function calculated using the initial migrated second data set, and setting the modified velocity model equal to the initial velocity model; and
iteratively performing:
generating a version of velocity model,
migrating the second data set using the version of velocity model to obtain a version of the migrated second data set,
calculating an updated value of the objective function using the version of the migrated second data,
if the updated value is smaller than the reference objective function value, set the reference objective function value equal to the calculated objective function, and set the modified velocity model equal to the version of the velocity model.

14. The apparatus of claim 13, wherein the data processing unit generates the version of velocity model according to predetermined rules that include observing spatial constraints related to differences between the version of velocity model and the initial velocity model.

15. The apparatus of claim 13, wherein the data processing unit performs a predetermined number of iterations or stops performing iterations when a predetermined criterion related is met.

16. The apparatus of claim 13, wherein the data processing unit generates the version of velocity model taking into consideration previous iterations' results.

17. The apparatus of claim 12, wherein
the interface receives a third data set, and
the data processing unit determines another modified velocity model that minimizes another objective function measuring differences between the first migrated data set and/or the second data set migrated using the modified velocity model, and the third data set migrated using the other modified velocity model.

18. The apparatus of claim 12, wherein
the interface receives at least one other data set, and
the data processing unit
generates a calendar-dependent modified velocity function of calendar time of acquiring the second dataset and the at least one other seismic data set, and
determines parameters of the calendar-dependent modified velocity function such that to minimize a calendar-dependent objective function measuring differences between the first migrated seismic data set, and the second data set and the at least one other seismic data migrated using respective velocity models calculated using the calendar-dependent velocity function.

19. A computer readable recording medium storing executable codes which, when executed by a computer, make the computer perform a method for migrating 4D seismic data, the method comprising:
receiving a first data set and a second data set that are vintages of the 4D seismic data;
migrating the first data set using an initial velocity model to obtain a first migrated data set; and
determining a modified velocity model that minimizes an objective function measuring differences between the first migrated data set and the second data set migrated using the modified velocity model.

20. The computer readable recording medium of claim 19, wherein the determining includes:
migrating the second data set using the initial velocity model to obtain initial migrated second data set;
setting a reference objective function value equal to a value of the objective function calculated using the initial migrated second data set, and setting the modified velocity model equal to the initial velocity model; and
iteratively performing:
generating a version of velocity model,
migrating the second data set using the version of velocity model to obtain a version of migrated second data set,
calculating an updated value of the objective function using the version of the migrated second data set,
if the updated value is smaller than the reference objective function value, set the reference objective function value equal to the updated value, and set the modified velocity model equal to the version of the velocity model.
